(19) United States
(12) Patent Application Publication
(10) Pub. No.: US 2016/0063636 A1
(43) Pub. Date: Mar. 3, 2016

(54) PREDICTIVE INSURANCE TRANSACTION ERROR SYSTEM

(71) Applicant: CERNER INNOVATION, INC., KANSAS CITY, MO (US)

(72) Inventors: DANIEL MARTIN FEIMSTER, SHAWNEE, KS (US); BRETT RICHARD WHISLER, KANSAS CITY, MO (US); CHRISTOPHER BRYAN HOGAN, LEE'S SUMMIT, MO (US); THOMAS OLIVER TWAIT, KANSAS CITY, MO (US); KEVIN PATRICK POMORSKI, KANSAS CITY, MO (US)

(21) Appl. No.: 14/471,072

(22) Filed: Aug. 28, 2014

(51) Int. Cl. G06Q 40/08

(52) U.S. Cl. CPC G06Q 40/08; G06Q 50/22

(57) ABSTRACT

Computerized systems and methods facilitate electronic medical insurance transactions by using a predictive model to predict errors prior to transmitting submissions to clearinghouses and/or insurance companies. A predictive model may be built using historical electronic medical insurance transaction data, which may include information from previous submissions and the responses (i.e., successful or error). The predictive model may be used to check submissions for electronic medical insurance transactions prior to transmitting the submissions to clearinghouses and/or insurance companies. As such, if an error response is predicted for a submission, an indication may be provided to a user entering the submission such that the user may make corrections and improve the likelihood of receiving a successful response for the electronic medical insurance transaction.

### BACKGROUND

In healthcare, there are a number of transactions between a healthcare provider and an insurance company (and/or intermediaries) that use electronic communications. For instance, one of the primary things a healthcare provider performs when registering a patient (beyond collecting pertinent medical history and reason for visit) is to verify medical insurance information, which is critical for future payment. Most healthcare providers use electronic communication means to acquire insurance eligibility and benefits information. Often, the transactions employ a communication protocol using an industry standard format to transfer required information through various intermediaries (“clearinghouses”) ultimately reaching the insurance company and returning a response. Other examples of electronic transactions in healthcare include: the submission of insurance claims for payment, and authorizations to get permission from an insurance company to provide a particular service.

Electronic medical insurance transactions do not always return a desired response (e.g., actual insurance benefit information in the case of an insurance eligibility transaction) and may instead provide an error message. The types of errors are categorized and in most cases are due to missing or incorrectly formatted data, or other input issues associated with the data submitted by the healthcare provider. In the case of medical insurance eligibility, error messages are typically coded to a set of standardized messages, which can be used across the industry. The level of errors is astoundingly high (relative to processing performance in other industries) at an estimated 18-20%.

### BRIEF SUMMARY

Embodiments of the present invention generally relate to building a predictive model based on historical medical insurance transaction data, which may include information regarding previous submissions for electronic medical insurance transactions and responses for each submission (e.g., a successful response or an error response). The predictive model may be built, for instance, by using machine learning techniques to analyze the historical medical insurance transaction data. The predictive model may be employed to predict whether submissions from healthcare providers are likely to result in an error response before the submissions are provided to the appropriate clearinghouse and/or insurance company. If an error response is predicted, an indication may be provided to the user entering the submission information who may decide to modify the submission information to increase the likelihood of getting a successful response for the transaction.

Accordingly, in one aspect, an embodiment of the present invention is directed to one or more computer storage media storing computer-useable instructions that, when used by one or more computing devices, cause the one or more computing devices to perform operations. The operations include receiving submission information entered by a user for a submission for an electronic medical insurance transaction. The operations further include predicting a likelihood of an error response for the submission based on the submission information and a predictive model trained on historical transaction data prior to transmitting the submission to a clearinghouse or insurance company.

In another embodiment, an aspect is directed to a computer-implemented method in a healthcare computing environment. The method includes receiving, via a first computing process, historical transaction data for a type of electronic medical insurance transaction, the historical transaction data including submission information for a plurality of previous submissions from one or more healthcare providers and response information for the plurality of previous submissions, the response information indicating whether an error response was returned for each of the plurality of previous submissions. The method also includes generating, via a second computing process, a predictive model based on the historical transaction data using one or more machine learning algorithms. The method further includes employing, via a third computing process, the predictive model to predict a likelihood of an error response for submissions of the type of electronic medical insurance transaction. The first, second, and third computing processes are performed by one or more computing devices.

A further embodiment is directed to a system comprising: a historical transaction database storing historical electronic medical insurance transaction data regarding a plurality of electronic medical insurance transactions, including information provided as submissions from one or more healthcare providers and an indication of a successful response or error response for each submission; one or more processors; and one or more computer storage media storing instructions that, when used by the one or more processors, cause the one or more processors to: access the historical medical insurance transaction data; and generate a predictive model based on the historical medical insurance transaction data.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system for generating a predictive model for electronic medical insurance transaction in accordance with an embodiment of the present invention;

FIG. 3 is a block diagram showing an example of a general outline for generating a predictive model in accordance with an embodiment of the present invention;

FIG. 4 is a block diagram of an exemplary system for using a predictive model to predict the likelihood of an error response for submissions for electronic medical insurance transactions in accordance with embodiments of the present invention;

FIG. 5 is a screenshot showing an exemplary user interface with an indication regarding the likelihood of an error response for a submission in accordance with an embodiment of the present invention;

FIG. 6 is a flow diagram showing a method for generating a predictive model based on historical electronic medical insurance data in accordance with an embodiment of the present invention;

FIG. 7 is a flow diagram showing a method for using a predictive mode to predict the likelihood of an error response for a submission for an electronic medical insurance transaction in accordance with an embodiment of the present invention; and

FIG. 8 is a flow diagram showing a method for using a predictive model to predict the likelihood of an error response based on incremental submission information in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention are generally directed to computerized methods and systems that provide for predicting an error for an electronic medical insurance transaction prior to transmitting a submission to a clearinghouse and/or insurance company. A predictive model may be generated using historical transaction data for a type of electronic medical insurance transaction. The historical transaction data may include submission information from previous submissions and whether a successful response or error response was received for each submission. For instance, machine learning techniques may be used to train a predictive model using the historical transaction data. The predictive model is employed to check submissions prior to transmitting the submissions to an appropriate clearinghouse and/or insurance company. In particular, the predictive model may predict whether an error response is likely for a given submission. This prediction may be in real-time as the user enters submission information or after the user completes entering the submission information. If an error response is predicted, an indication may be provided to the user. This allows the user to correct the submission prior to the submission being transmitted to the appropriate clearinghouse and/or insurance company. This, in turn, reduces the number of error responses received for electronic medical insurance transactions and thereby reduces expenses for healthcare facilities. For instance, healthcare facilities' resources are not wasted in correcting previous submissions that resulted in error responses. Additionally, because there is typically a financial cost per submission for many types of electronic medical insurance transactions, reduced re-submissions from errors will result in lower costs for the healthcare facilities. Furthermore, by training the predictive model using transaction data, the predictive model may be dynamic as it may be modified over time as additional transaction data is collected. This allows the predictive model to reflect changes in the ways clearinghouses and/or insurance companies handle submissions and better predict errors.

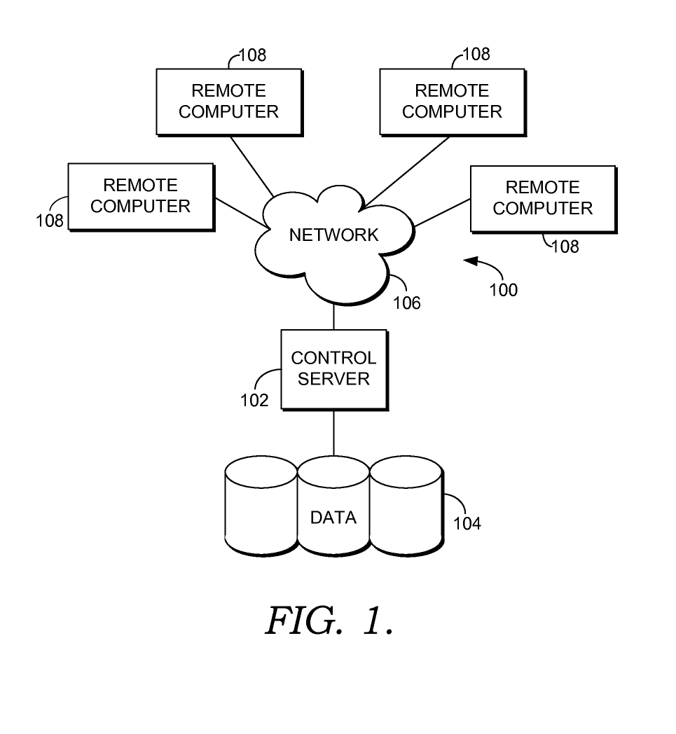

Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database cluster 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Computer storage media does not comprise signals per se. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

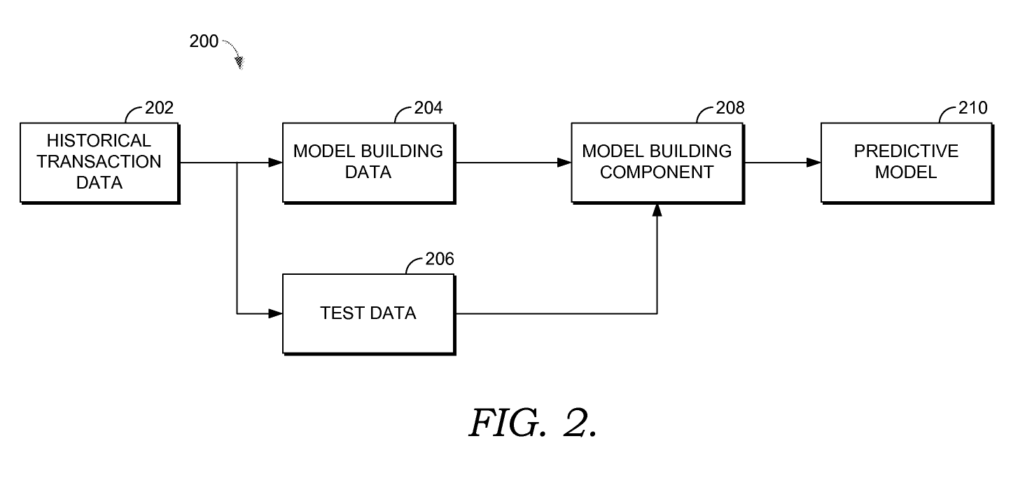

Referring now to FIG. 2, a block diagram is provided illustrating an exemplary system 200 in which a predictive model 210 is built using historical transaction data 202. The historical transaction data 202 includes information provided in previous submissions. This may include, for instance, patient information (e.g., patient name, patient date of birth, patient social security number, etc.) and insurance information (e.g., insurance company name, insurance account number or other identifier, etc.). The historical transaction data 202 also includes information regarding responses for each submission. This may include, for instance, an indication of whether the submission resulted in a successful response or if an error response was returned. If an error response was returned, the information may include information indicating a reason for the error. This information may be in the form of a response code that represents the type of error.

The historical transaction data 202 is divided into model building data 204 and test data 206. A model building component 208 employs the model building data to generate one or more models, which are then tested using the test data to verify the accuracy of the models. The output is a predictive model 210. Although only a single predictive model is shown in FIG. 2, it should be understood that any number of predictive models may be generated. The model building component 208 may generally employ any machine learning techniques or other algorithms to analyze the historical transaction data 202 and generate the predictive model 210.

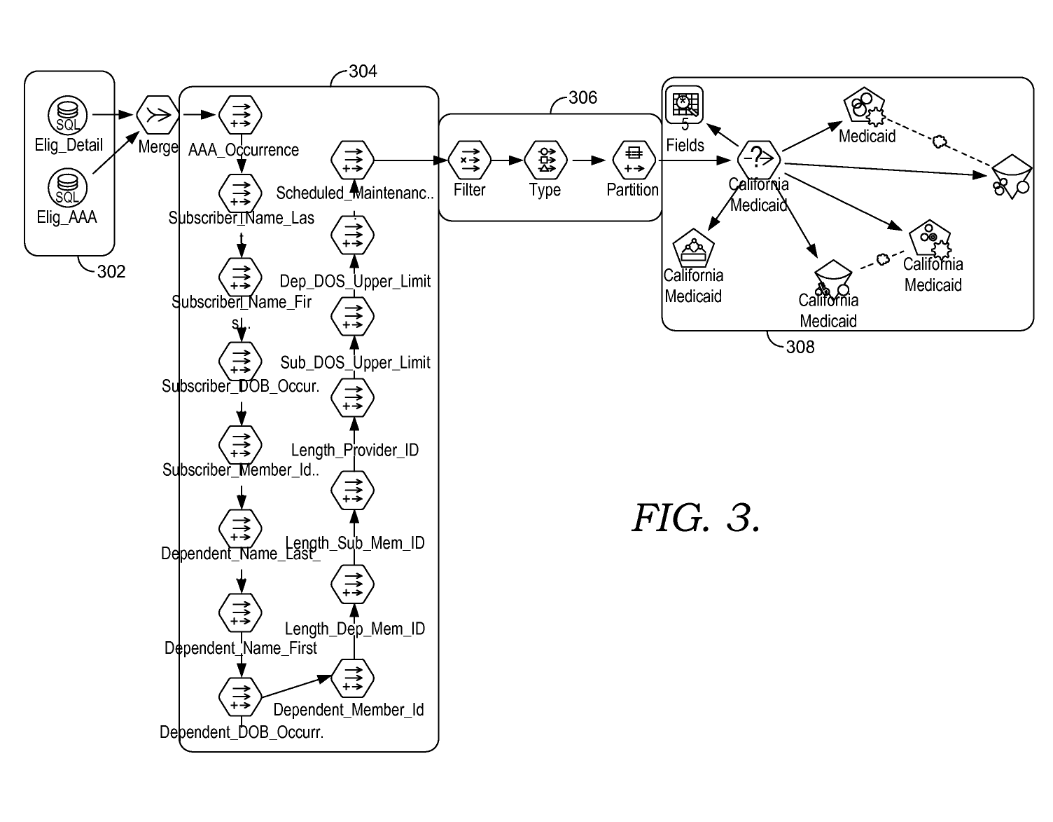

By way of example to illustrate, FIG. 3 provides a general outline for generating a predictive model. Two source nodes 302 (submission information and response information) are used to pull in historical transaction data from a transaction services database and the two datasets are merged together. The next series of nodes, called derive nodes 304, are used for formatting, creating insurance company specific rules, and preparing the data. For example, certain insurance company's scheduled downtimes may be known; therefore a rule may be generated stating “1” if transaction occurred within that downtime and “0” otherwise. The transform nodes 306 include filter, type, and partition nodes that eliminate stated fields, categorize input and target fields, and partition the data into training and testing sets, respectively.

The final section of the process shown in FIG. 3 builds and generates a predictive model using modeling nodes 308. The modeling nodes 308 produce a model based on associated algorithms. By way of example only and not limitation, the modeling nodes may employ the QUEST algorithm (quick, unbiased, efficient, statistical, tree), auto classifier algorithms, and/or auto cluster algorithms (e.g., K-means algorithm, Kohonen algorithms, and two step cluster algorithms).

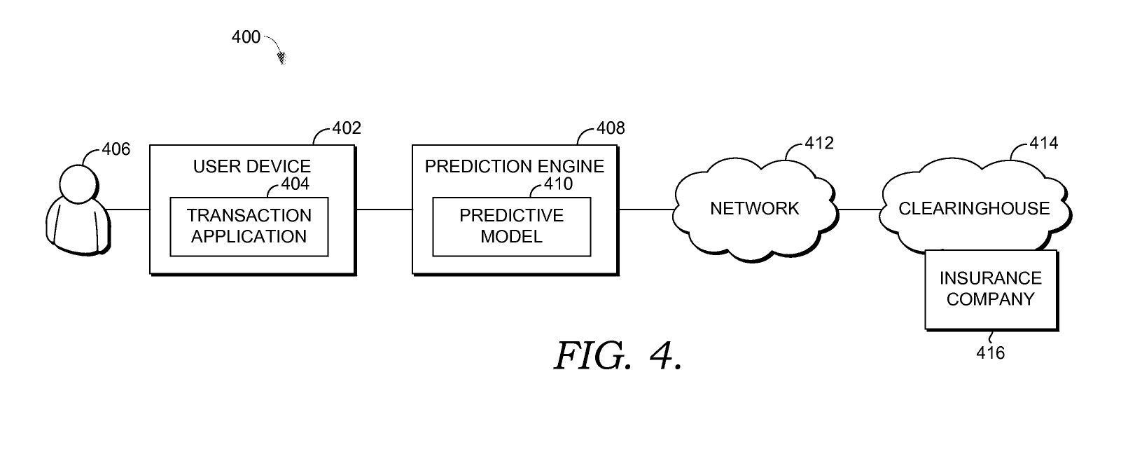

A predictive model built in accordance with embodiments of the present invention is used to predict whether submissions will result in errors before the submissions are transmitted to clearinghouses and/or insurance companies. FIG. 4 provides a block diagram illustrating an exemplary system 400 in which a predictive model 410 is used to predict errors for submissions. As shown in FIG. 4, a transaction application 404 is provided on a user device 402. The transaction application 404 may generally be any software that allows the user 406 to enter information of a submission for an electronic medical insurance transaction with a clearinghouse and/or insurance company. The electronic medical insurance transaction may be any type of electronic transaction between a healthcare provider and clearinghouse and/or insurance company. By way of example only and not limitation, this may include verifying medical insurance eligibility, submitting an insurance claim, or getting authorization for a service.

A prediction engine 408 is provided that employs a predictive model 410 (e.g., a predictive model generated by the model building component 208 of FIG. 2) to predict whether a submission entered using the transaction application 404 will result in an error prior to transmitting the submission to a clearinghouse 414 and/or insurance company 416. While the predication engine 408 is shown separate from the user device 402, in some embodiments, the prediction engine 408 may be provided locally on the user device 402. In other embodiments, the prediction engine 408 may be provided remotely from the user device 402. For instance, the prediction engine 408 may be provided as a cloud-based service.

In some embodiments, the prediction engine 408 may analyze submission information as the user is entering the information using the transaction application 404. For instance, the transaction application 404 may provide a submission user interface (UI) that includes a number of data fields to enter submission information. As the user enters information into each field, the prediction engine 408 may check the entered information for any errors. In some instances, an indication may be provided in the submission UI to indicate entered submission information is predicted to be successful or result in an error. For instance, each field may be highlighted a particular color as the user enters information into each field (e.g., green to indicate the information is likely to result in a successful response or red to indicate the information is likely to result in an error). As another example, a checklist may be provided that validates certain aspects, such as presence of data, valid formatting, etc. If any information is determined to likely result in an error, an indication may be provided and presented to the user regarding why the submission is likely to result in an error and/or what corrections the user should make to try to avoid the error. For example, suppose the submission information includes a patient identifier and the model indicates the patient identifier should be between 8 and 12 numbers, but the entered patient identifier includes 13 numbers. Based on this determination, an indication may be provided to the user that the patient identifier should include between 8 and 12 numbers.

In other embodiments, the prediction engine 408 may analyze submission information after the user completes entering the information. For instance, a UI element may be provided as part of the submission UI that allows a user to select to check the submission for potential errors. As another example, the prediction engine 408 may analyze the submission when the user selects a UI element to submit the information (e.g., a “submit” button), although the analysis may be performed before the submission is actually transferred to any clearinghouse and/or insurance company. If the prediction engine 408 determines the submission is not predicted to result in an error response, the submission is provided to the appropriate clearinghouse 414 and/or insurance company 416 for transaction processing. The prediction engine 408 may forward the submission to the clearinghouse 414 and/or insurance company 416 or the prediction engine 408 may provide an indication to the transaction application 404 that then causes the transaction application 404 to transmit the submission to the clearinghouse 414 and/or insurance company 416.

Alternatively, if the prediction engine 408 predicts the submission is likely to result in an error response, an indication is provided and presented to the user to indicate the submission is likely to result in an error. In some embodiments, information regarding the reason for the error and/or modifications the user can make to try to avoid the error may also be provided to assist the user. The user can then decide whether to submit the information with or without any changes. If the user makes any changes, the prediction engine 408 may analyze the submission information again based on the changes.

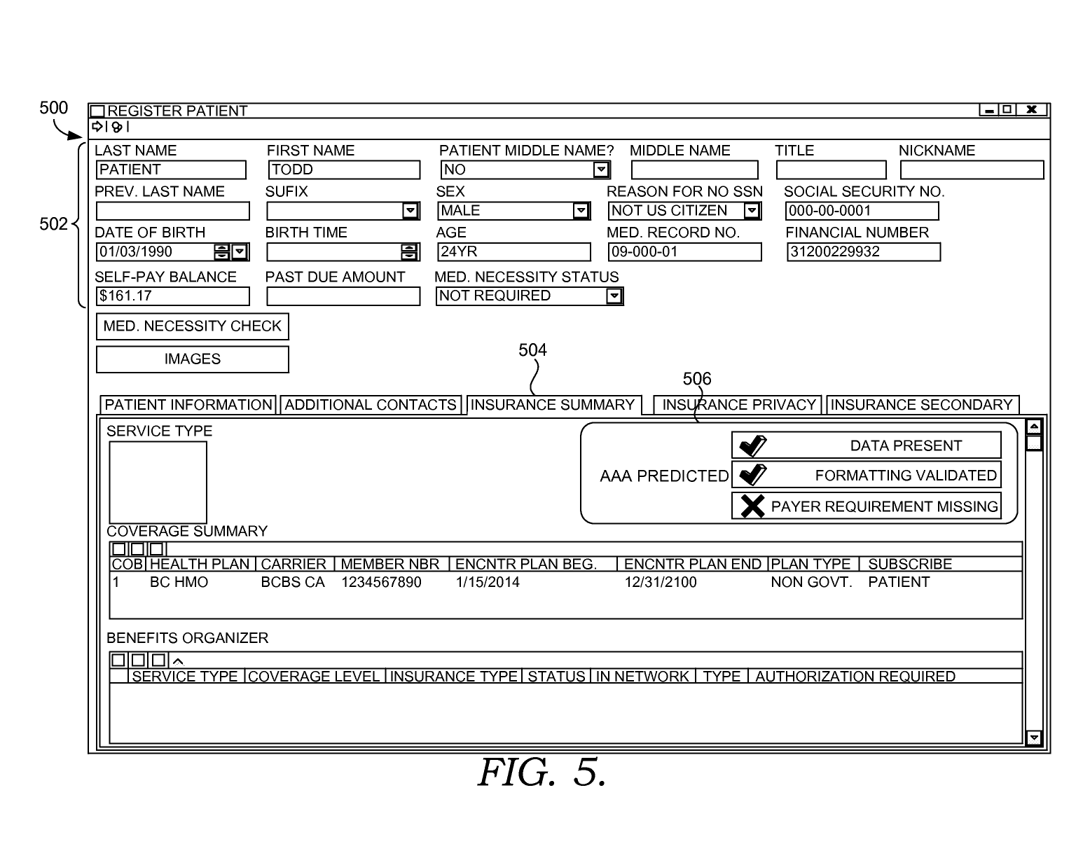

By way of example to illustrate, FIG. 5 shows a screenshot of a UI 500 that allows a user (e.g., a clinician at a healthcare provider) to register a patient and check for medical insurance eligibility. As shown in FIG. 5, the UI 500 includes a number of data fields 502 for entering patient information, which may be used as part of a submission for an electronic medical insurance transaction for medical insurance eligibility. The UI 500 also includes an insurance summary area 504 for entering insurance information that may also be used as part of the submission. In the example of FIG. 5, a user has entered patient and medical insurance information for the submission and the submission information has been analyzed using a predictive model. As a result, information is provided in the box 506 regarding the likelihood of an error for this submission. In particular, the information indicates that data is present and has been validated (as indicated by the check marks). However, a payer requirement is missing (as indicated by the X mark). This indicates to the user that an error response is likely to be received if the user submits the submission without any modifications. It should be understood that the information provided in the box 506 is provided by way of example only and more or less information may be provided in various embodiments of the present invention. For instance, a simple indication that an error response is likely may be provided. Alternatively, more information could be provided, such as information regarding what payer requirement is missing. However, the more information that can be provided to the user regarding why a submission is likely to result in an error response, the more likely the user will be able to modify the submission information to get a successful response.

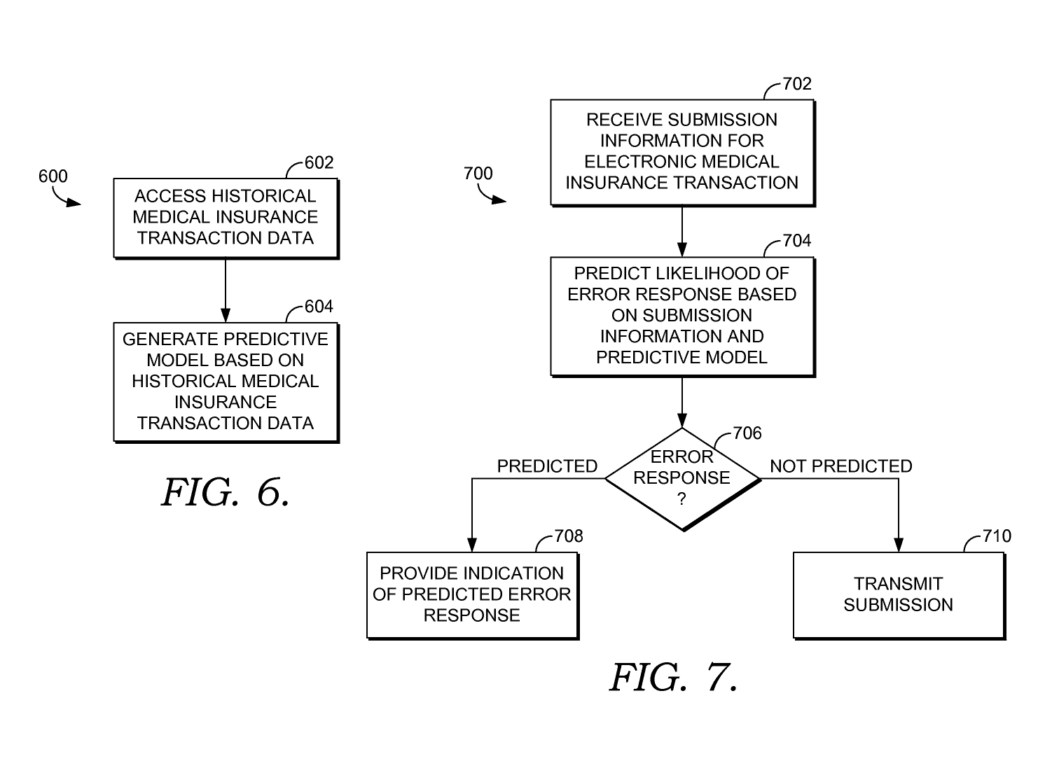

Turning now to FIG. 6, a flow diagram is provided that illustrates a method 600 for generating a predictive model in accordance with an embodiment of the present invention. As shown at block 602, historical transaction data is accessed for a type of medical insurance transaction. For instance, the historical transaction data may be for medical insurance eligibility, claim submission, or service authorization transactions that were performed by one or more healthcare providers with one or more clearinghouses and/or insurance companies. The historical transaction data may include submission information from submissions and the responses for each submission (e.g., successful response or error response, which may include an error code or other information identifying a reason for the error response).

In some embodiments, a predictive model may be generated based on historical transaction data from a single healthcare provider. In other embodiments, historical transaction data from multiple healthcare providers may be used. Using historical transaction data from multiple healthcare providers may allow for more information to provide a more accurate model.

Additionally, in some embodiments, the historical transaction information may be for a single clearinghouse and/or insurance company. Although many types of electronic medical insurance transactions use standard protocols and error codes, the implementation of the electronic medical insurance transactions by different clearinghouses and insurance companies may vary. For instance, one insurance company may return an error response for a submission with a particular data format, while another insurance company will provide a successful response for a submission with the same data format. Accordingly, by using transaction information for a single clearinghouse and/or insurance company, a predictive model specific to that clearinghouse and/or insurance company may be built (i.e., a predictive model could be generated for each clearinghouse and/or insurance company). Alternatively, historical transaction data may be used from multiple clearinghouses and/or insurance companies. This may provide a single predictive model that may be used across the various clearinghouses and/or insurance companies. However, such a single predictive model may not be as accurate as individual predictive models due to variations in how each clearinghouse and/or insurance company handles the electronic medical insurance transactions.

A predictive model is generated based on the historical transaction data, as shown at block 604. Any of a variety of different known machine learning algorithms may be used to build the predictive model based on the historical transaction data. By way of example only and not limitation, the machine learning algorithms employed may be the QUEST algorithm (quick, unbiased, efficient, statistical, tree), auto classifier algorithms, and/or auto cluster algorithms (e.g., K-means algorithm, Kohonen algorithms, and two step cluster algorithms).

With reference now to FIG. 7, a flow diagram is provided that illustrates a method 700 for predicting the likelihood of an error for a submission in accordance with an embodiment of the present invention. As shown at block 702, submission information is received for an electronic medical insurance transaction. The submission information is received when the user has entered information and is ready to submit the submission but before the submission is actually communicated to a clearinghouse and/or insurance company for processing. For instance, the user may employ a UI that allows the user to enter the submission information and select to provide the submission for the transaction.

A likelihood that the submission would return an error response if transmitted to a clearinghouse and/or insurance company is determined, as shown at block 704. In particular, a predictive model (e.g., such as a model generated in accordance with the method 600 of FIG. 6) is used to analyze the submission information to make the determination. In some embodiments, a number of predictive models may be available. Each predictive model may correspond with, for instance, a particular clearinghouse, insurance company, and/or type of electronic medical insurance transaction (or subset group of clearinghouses, insurance companies, and/or types of electronic medical insurance companies). In such embodiments, the process includes selecting a predictive model appropriate for the submission. The predictive model may be selected, for instance, based on the clearinghouse and/or insurance company for the transaction and/or based on the type of electronic medical insurance transaction (which may be determined based on the submission application being used and/or the submission information entered by the user). Any and all such combinations and variations thereof are contemplated to be within the scope of embodiments of the present invention.

A determination is made at block 706 regarding whether an error response is likely based on the predictive model. If an error response is predicted, an indication of the predicted error response is provided for display to the user, as shown at block 708. The amount of information provided for display to the user may vary in embodiments of the present invention. For instance, in some instances, only an indication that an error response is likely may be provided. In other instances, more robust information may be provided to help the user identify what is likely to cause the error response and/or how the user may adjust the submission information to prevent the error response. In any case, the indication provides the user with the opportunity to recognize that an error response is likely for the submission before it is submitted. As such, the user may modify the submission information, if desired. In some instances, if the user modifies the submission information, the process of predicting the likelihood of an error response at block 704 may be repeated.

Alternatively, if an error response is not predicted at block 706, the submission is transmitted to an appropriate clearinghouse and/or insurance company for processing, as shown at block 710. In some instances, the submission may be forwarded to the appropriate clearinghouse and/or insurance company by a prediction engine (e.g., the prediction engine 408 of FIG. 4) that analyzed the submission. In other instances, an indication that an error response is not likely may be provided to the application used to enter the submission (e.g., the transaction application 404 of FIG. 4) and the application may then transmit the submission for processing.

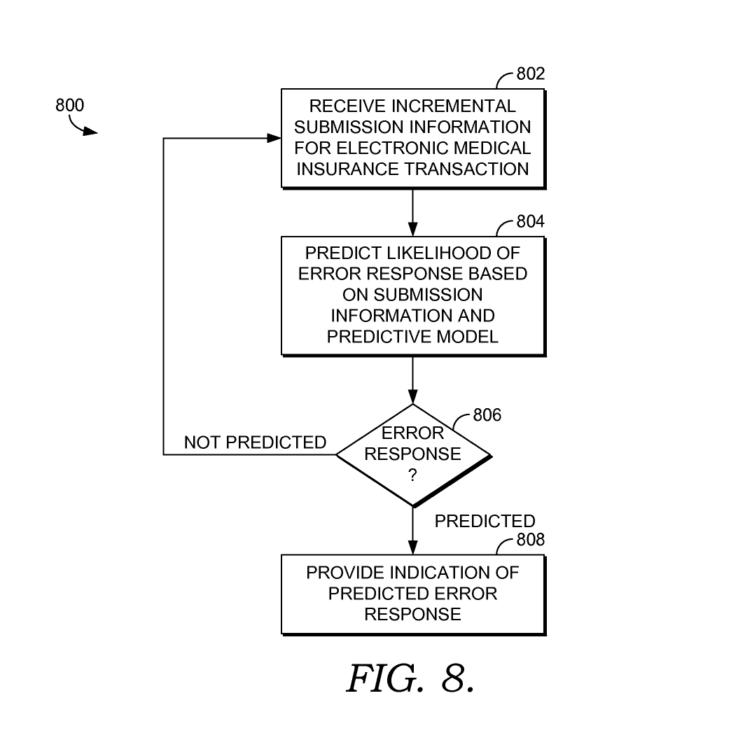

FIG. 8 provides a flowing diagram showing a method 800 for checking submission information incrementally entered by the user for the likelihood of an error response in accordance with embodiments of the present invention. As shown at block 802, incremental submission information is received for an electronic medical insurance transaction. The incremental submission information may include a portion of the information required for a submission. For instance, in some embodiments, submission information may be received each time a user completes a particular data field.

A likelihood of an error response is determined based on the incremental submission information, as shown at block 804. In particular, a predictive model (e.g., such as a model generated in accordance with the method 600 of FIG. 6) is used to analyze the incremental submission information to make the determination. The predictive model may be selected from multiple available predictive models in some embodiments, for instance, based on the clearinghouse and/or insurance company for the transaction and/or the type of electronic medical insurance transaction. In some instances, the received incremental submission information may be analyzed alone; while in other instances, the received incremental submission information may be analyzed in conjunction with previously entered information. For instance, the information currently entered for one data field may be analyzed in conjunction with information previously entered for another data field.

A determination is made at block 806 regarding whether an error response is predicted. If an error response is not predicted, the process of receiving incremental submission information at block 802 and predicting a likelihood of an error response at block 804 is repeated as the user continues to enter submission information until the user enters all submission information. Alternatively, as shown at block 808, if an error response is predicted, an indication of the predicted error response is provided for display to the user. This may include only an indication that an error is predicted or may include other information, such as a reason for the predicted error response and/or how the user may modify the submission information to prevent an error response. As such, the user may modify the submission information based on the indication.

As can be understood, embodiments of the present invention provide for the generation of predictive models based on historical electronic medical insurance transaction data and use of the predictive models to predict the likelihood of an error response for a given submission for an electronic medical insurance transaction prior to transmitting the submission to a clearinghouse and/or insurance company. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by one or more computing devices, cause the one or more computing devices to perform operations comprising:
receiving submission information entered by a user for a submission for an electronic medical insurance transaction; and
predicting a likelihood of an error response for the submission based on the submission information and a predictive model trained on historical transaction data prior to transmitting the submission to a clearinghouse or insurance company.

2. The one or more computer storage media of claim 1, wherein the submission information is received before the user completes all information for the submission such that the submission information is partial information, and wherein the likelihood of an error response is determined based on the partial information.

3. The one or more computer storage media of claim 1, wherein the submission information is received after the user completes all information for the submission.

4. The one or more computer storage media of claim 3, wherein the operations further comprise:
determining an error response is unlikely for the submission; and
communicating the submission to a clearinghouse or insurance company for the electronic medical insurance transaction.

5. The one or more computer storage media of claim 1, wherein the operations further comprise:
determining an error response is likely for the submission; and
providing an indication of a predicted error response based on determining an error response is likely for the submission.

6. The one or more computer storage media of claim 5, wherein the operations further comprising:
determining a reason for the predicted error response; and
providing at least one selected from the following: an indication of the reason for the predicted error response; and an indication of how to change the submission information based on the reason for the predicted error response.

7. The one or more computer storage media of claim 6, wherein the operations further comprise:
identifying a data field in a submission user interface used for entering the submission information as corresponding with the reason for the predicted error response; and
causing the data field to be displayed differently to draw the user's attention to the data field.

8. The one or more computer storage media of claim 1, wherein the predictive model is specific to a particular insurance company or a particular clearinghouse.

9. The one or more computer storage media of claim 8, wherein the predictive model is selected from a plurality of available predictive models based on at least a portion of the submission information identifying the particular insurance company or the particular clearinghouse.

10. A computer-implemented method in a healthcare computing environment comprising:
receiving, via a first computing process, historical transaction data for a type of electronic medical insurance transaction, the historical transaction data including submission information for a plurality of previous submissions from one or more healthcare providers and response information for the plurality of previous submissions, the response information indicating whether an error response was returned for each of the plurality of previous submissions;
generating, via a second computing process, a predictive model based on the historical transaction data using one or more machine learning algorithms; and
employing, via a third computing process, the predictive model to predict a likelihood of an error response for submissions of the type of electronic medical insurance transaction;
wherein the first, second, and third computing processes are performed by one or more computing devices.

11. The method of claim 10, wherein the historical transaction data is from transactions with a particular insurance company or a particular clearinghouse such that the predictive model is specific to the particular insurance company or the particular clearinghouse.

12. The method of claim 11, wherein the method further comprises:
receiving a second set of historical transaction data for a second insurance company or a second clearinghouse; and
generating a second predictive model based on the second set of historical transaction data that is specific to the second insurance company or the second clearinghouse.

13. The method of claim 10, wherein the method further comprises:
transmitting a submission to a clearinghouse or insurance company based on a determination made using the predictive model that an error response is unlikely for the submission.

14. The method of claim 10, wherein the method further comprises: providing an indication of a predicted error response based on a determination made using the predictive model that an error response is unlikely for the submission.

15. The method of claim 14, wherein the method further comprises:
determining a reason for the predicted error response; and
providing at least one selected from the following: an indication of the reason for the predicted error response; and an indication of how to change the submission information based on the reason for the predicted error response.

16. The method of claim 15, wherein the method further comprises:
identifying a data field in a submission user interface used for entering the submission information as corresponding with the reason for the predicted error response; and
causing the data field to be displayed differently to draw the user's attention to the data field.

17. A system comprising:
a historical transaction database storing historical electronic medical insurance transaction data regarding a plurality of electronic medical insurance transactions, including information provided as submissions from one or more healthcare providers and an indication of a successful response or error response for each submission;
one or more processors; and
one or more computer storage media storing instructions that, when used by the one or more processors, cause the one or more processors to:
access the historical medical insurance transaction data; and
generate a predictive model based on the historical medical insurance transaction data.

18. The system of claim 17, wherein the instructions further cause the one or more processors to:
receive submission information entered by a user for a current submission for a current electronic medical insurance transaction; and
predict a likelihood of an error response for the current submission based on the submission information and the predictive model prior to transmitting the current submission to a clearinghouse or insurance company.

19. The system of claim 18, wherein the instructions further cause the one or more processors to: transmit the current submission to the clearinghouse or insurance company based on predicting that an error response is unlikely for the submission.

20. The system of claim 18, wherein the instructions further cause the one or more processors to: provide an indication of a predicted error response based on predicting that an error response is unlikely for the submission
